(19) United States
(12) Patent Application Publication
(10) Pub. No.: US 2025/0199836 A1
(43) Pub. Date: Jun. 19, 2025

(54) ENERGY EFFICIENT COMPUTING THROUGH ADAPTIVE PARAVIRTUALIZATION FOR VM MANAGEMENT

(71) Applicant: Red Hat, Inc., Raleigh, NC (US)

(72) Inventors: Leigh Griffin, Waterford (IE); Rachel Lawton, Waterford (IE)

(21) Appl. No.: 18/540,681

(22) Filed: Dec. 14, 2023

(51) Int. Cl. G06F 9/455

(52) U.S. Cl. CPC G06F 9/45558; G06F 2009/4557; G06F 2009/45591

(57) ABSTRACT

Systems and methods for optimizing energy usage of a computing device running one or more VMs are disclosed. Energy consumption data for each of a plurality of virtual machines (VMs) executing on a computing device is monitored. A machine learning (ML) model is used to generate an energy usage prediction for each of the plurality of VMs based on the energy consumption data for each of the plurality of VMs. An allocation of resources for one or more of the plurality of VMs may be adjusted based on the energy consumption data and the set of energy usage predictions for each of the plurality of VMs to minimize an energy usage of each of the plurality of VMs.

### TECHNICAL FIELD

Aspects of the present disclosure relate to resource management in virtual machine-based systems, and more particularly, to adaptive resource allocation to optimize performance of virtual machines while minimizing energy usage of devices that they execute on.

### BACKGROUND

A virtualization engine may be a platform for developing and running virtualized applications and may allow applications and the data centers that support them to expand from just a few machines and applications to thousands of machines that serve millions of clients.

With traditional virtualization, a hypervisor has to emulate hardware interactions and manage multiple virtual machines (VMs) competing for the same resources using management techniques (e.g., round robin, Qbase) so that the VMs are unaware that they are virtualized. This results in hypervisors in traditional virtualization being very heavy weight and requiring a more powerful virtualization stack. Para-virtualization offers an increased ability for optimization as a guest operating system of the VM is more aware of its environment. Para-virtualization is effective in situations where more immediate access to underlying hardware is required for performance reasons. For timing-critical functions, para-virtualization can provide the speed of native code alongside some of the benefits of virtualization, such as sharing hardware between multiple operating systems.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram illustrating the example system of FIG. 1 while collecting energy consumption data from different VMs, in accordance with some embodiments of the present disclosure.

FIG. 3 is a block diagram illustrating the example system of FIG. 1 while adjusting the resources allocated to certain VMs, in accordance with some embodiments of the present disclosure.

FIG. 4 is a flow diagram of a method for optimizing energy usage of a computing device running one or more VMs, in accordance with some embodiments of the present disclosure.

FIG. 5 is a block diagram of an example computing device that may perform one or more of the operations described herein, in accordance with some embodiments of the present disclosure.

### DETAILED DESCRIPTION

Edge devices often operate with limited computing resources, power, cooling, and connectivity. Examples of edge devices include assembly line tools, IoT gateways, points of sale, and industrial controllers. Edge devices can also be hard to access, or located in settings with little or no on-site technical expertise. Because such devices have limited power and capability, it is essential to use the capabilities of such devices efficiently to increase the workload that the device can handle.

Virtualization can abstract the resources of an edge device into discrete pools that may be used to configure and deploy VMs on which the functions of the edge device can execute. Techniques such as para-virtualization can help minimize the energy required for using VMs by not requiring emulation of hardware interactions and providing more straightforward VM management and access to resources since the guest operating system has a natural awareness of the virtualized environment. However, para-virtualization alone often does not fully maximize the available power of an edge device.

The present disclosure addresses the above-noted and other deficiencies by providing techniques for optimizing energy usage of a computing device running one or more VMs. Energy consumption data for each of a plurality of VMs executing on a computing device is monitored. Each of the plurality of VMs is executed as a para-virtualization by an adaptive para-virtualization management module that comprises a set of rules for adjusting the allocation of resources for each of the one or more VMs. A machine learning (ML) model is used to generate an energy usage prediction for each of the plurality of VMs based on the energy consumption data for each of the plurality of VMs. The adaptive para-virtualization management module may adjust an allocation of resources for one or more of the plurality of VMs based on the energy consumption data and the set of energy usage predictions for each of the plurality of VMs to minimize an energy usage of each of the plurality of VMs.

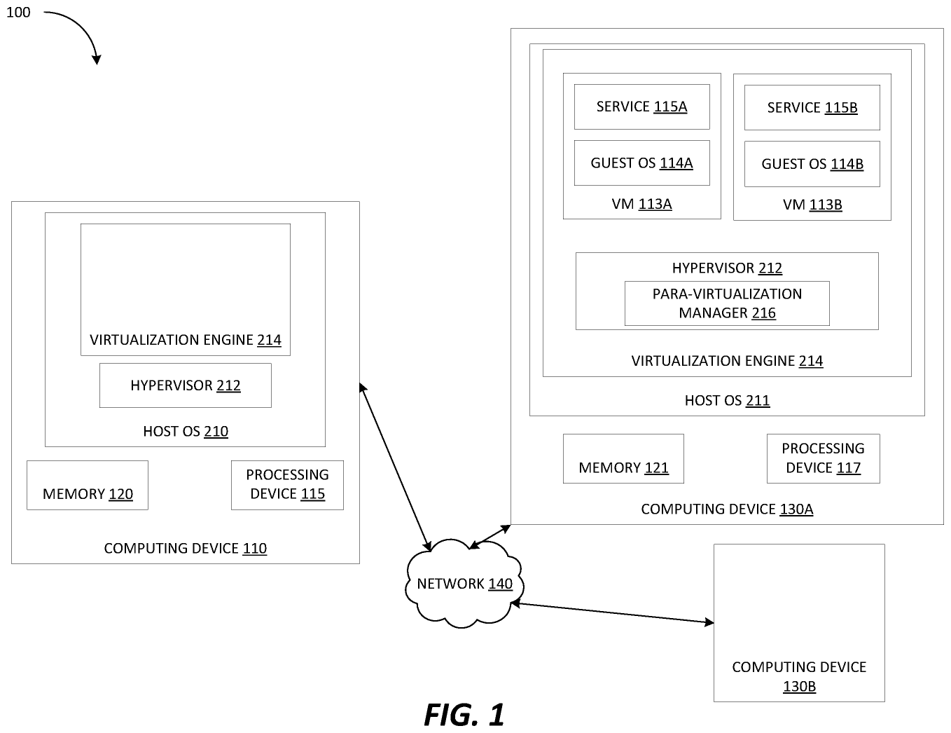

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110 and computing devices 130. Each computing device may include hardware such as processing device 115 (e.g., processors, central processing units (CPUs), memory 120 (e.g., random access memory 120 (e.g., RAM), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 of computing device 110 and 130 respectively, as discussed in more detail below. The host OS of a computing device 110 and 130 may manage the execution of other components (e.g., software, applications, etc.) and/or may manage access to the hardware (e.g., processors, memory, storage devices etc.) of the computing device. In some embodiments, computing device 110 may implement a control plane (e.g., as part of a container orchestration engine) while computing devices 130 may each implement a compute node (e.g., as part of the container orchestration engine).

In some embodiments, a virtualization engine 214, such as the Red Hat™ OpenShift™ module, may execute on the host OS 210 of computing device 110 and the host OS 211 of each computing device 130, as discussed in further detail herein. The virtualization engine 214 may be a platform for developing and running virtualized and/or containerized applications and may allow applications and the data centers that support them to expand from just a few machines and applications to thousands of machines that serve millions of clients.

The computing devices 130A and 130B may be edge devices such as assembly line tools, IoT gateways, points of sale, and industrial controllers that have to operate with limited computing resources, power, cooling, and connectivity. They can also be hard to access, or in settings with little or no on-site technical expertise. In some embodiments, the computing devices 130A and 130B may form a domain. A domain may include of a group of devices that share the same configuration, policies, and identity stores. The shared properties allow the devices within the domain to be aware of each other and operate together. The computing devices 130A and 130B may all be individual devices that are a part of a domain representing e.g., a fleet of internet of things (IoT) devices.

The virtualization engine 214 may include a hypervisor 212, which may also be known as a virtual machine monitor (VMM). Although shown as a component of the virtualization engine 214, in some embodiments the hypervisor 212 may run on top of the host OS 211, or may run directly on host hardware (e.g., computing device 130A hardware) without the use of the host OS 211. The hypervisor 212 may manage system resources, including access to processing device 117, memory 121, other storage devices (e.g., HDDs, SSDs), network resources (network cards and routers, along with firewall, WAN optimization, and network address translation (NAT) hardware) and/or other devices (e.g., sound cards, video cards, etc.). The hypervisor 212 may emulate the hardware (or other physical resources) of the computing device 130A to provide virtual resources which may be used by VMs to execute software/applications, as discussed in more detail herein. A VM may be, for example, a hardware emulation, a full virtualization, a para-virtualization, or an operating system-level virtualization VM.

The virtualization engine 214 may use a consistent set of application programming interfaces (APIs) to abstract those virtual resources provided by the hypervisor 212 one step further into discrete pools that may be used to configure and deploy VMs (e.g., VMs 113) and services/applications (e.g., services 115) that administrators and users may interact with directly. The virtualization engine 214 may include a deployment controller to handle creation of VMs as well as provisioning of such VMs with virtual applications. The deployment controller may also function to manage the operations of the virtual applications. For example, the virtualization engine 214 may utilize the deployment controller to create virtual switches (and a VM for the switch to run on) as well as manage the operations of the virtual switch (e.g., configuring/modifying rules and groups, managing connections with other virtual network functions (VNFs) and handling diagnostic tasks). The VMs 113 may be isolated, in that they are not connected to any other device or component of computing device 100, whether virtual or otherwise.

In one embodiment, each VM 113 may be a software implementation of a machine (e.g., a software implementation of a computing device) that includes its own operating system (referred to as guest OS 114) and executes services such as services 115A and 115B. Each of the services 115 may be an application program, application, or software such as a virtual network function (VNF).

VMs 113A and 113B may execute on computing device 130A using para-virtualization. Para-virtualization is a virtualization technique which involves running modified versions of a guest operating system 114. The para-virtualized guest operating system is modified to be aware that it is being virtualized and that it is using a shared pool of resources that can grow or shrink. With traditional virtualization, a hypervisor has to emulate hardware interactions and manage multiple VMs competing for the same resources using management techniques (e.g., round robin, Qbase) so that the VMs are unaware that they are virtualized. This results in hypervisors in traditional virtualization being very heavy weight and requiring a more powerful virtualization stack. However, para-virtualization offers an increased ability for optimization as the guest operating system is more aware of its environment. Para-virtualization is effective in situations where more immediate access to underlying hardware is required for performance reasons. For timing-critical functions, para-virtualization can provide the speed of native code alongside some of the benefits of virtualization, such as sharing hardware between multiple operating systems. For example, software instructions from the guest operating system 114 running inside a virtual machine 113 can use “hypercalls” that communicate directly with the hypervisor 212. This provides an interface very similar to software running natively on the host hardware and performance is generally close to running a bare-metal, non-virtualized operating system.

The use of para-virtualization also ensures that the energy required for using VMs is minimized and allows greater visibility (i.e., no emulation of hardware interactions, more straightforward VM management) and access to resources due to the guest operating system 114's natural awareness of the virtualized environments.

The hypervisor 212 may include a para-virtualization manager 216 that functions to provide the VMs 113 as para-virtualizations and to allocate the resources of the computing device 130A based on the energy usage of each VM 113 and/or energy usage of the computing device 130A, as discussed in further detail herein.

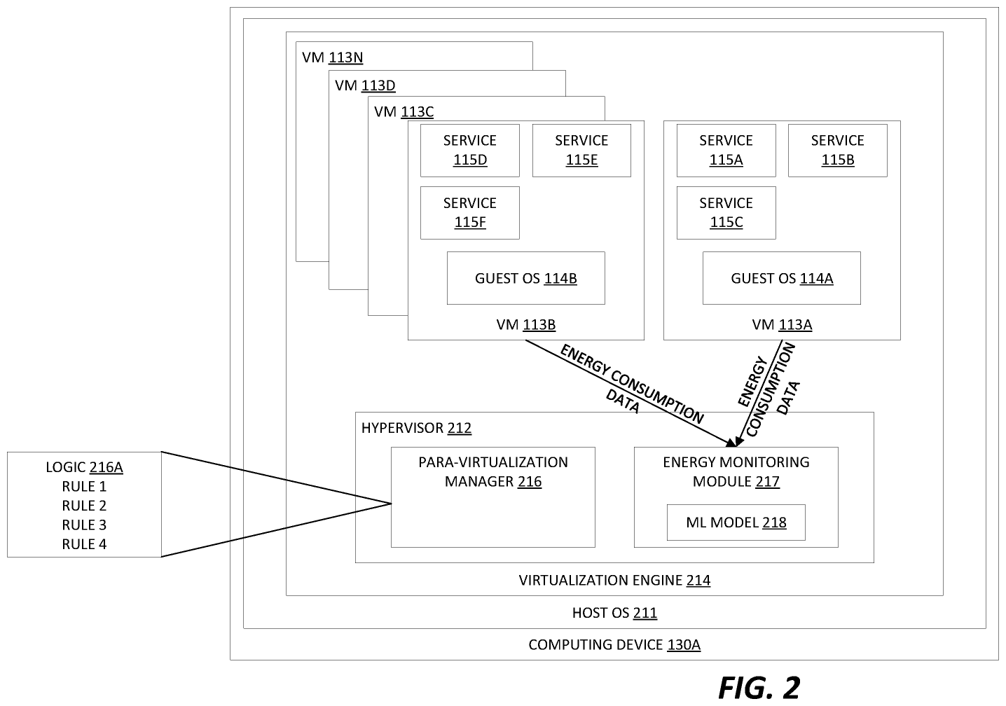

Referring now to FIG. 2, the hypervisor 212 may also include an energy monitor module 217 which may function to monitor the energy usage of all of the VMs 113 (and the individual services 115 hosted on each VM 113) executing on computing device 130A as well as the energy usage of the computing device 130A itself, as discussed in further detail herein.

The energy monitor module 217 may use hardware and software performance counters, hardware-specific monitoring features and operating system-specific features to monitor energy consumption data on a per VM 113 and per service 115 basis. The energy monitor module 217 may also utilize machine learning models to learn/estimate energy consumption on a per VM 113 and per service 115 basis. The para-virtualization manager 216 may use the energy consumption data and energy consumption estimates received from the energy monitor module 217 to scale the amount of resources allocated to certain VMs 113 as discussed in further detail herein. Energy consumption data may refer to the energy consumption attributable to each of the different resources (e.g., CPU, memory and networking resources of computing device 130A) in the aggregate.

The energy monitor module 217 may use a set of hardware performance counters which may each be a special-purpose register built into a CPU or processing device of the computing device 130A to count certain events that take place at the CPU level, such as the number of cycles and instructions that a service 115 executed, its associated cache misses and accesses to off-chip memory, among other examples. The energy monitor module 217 may also use a set of software performance counters, each of which may comprise code that monitors, counts, or measures events in the services 115.

The energy monitor module 217 may also use hardware-specific monitoring features such as e.g., the running average power limit (RAPL), which is a feature of CPUs that provides information about the energy consumption of different domains (e.g., CPU or RAM) in real time. The energy monitor module 217 may also use operating system-specific monitoring features such as e.g., the advanced configuration and power interface (ACPI), which is an open standard that operating systems can use to discover and configure computer hardware components. More specifically, the ACPI interface provides information including e.g., the power management features and different power states (e.g., active, idle, sleep) that the computing device 130A (and each VM 113) supports, a description of what power resources (power planes and clock sources) the computing device 130A needs in each power state that it supports, and a description of what power resources the computing device 130A needs in order to return to the active state from a sleeping or idle state.

As the energy monitor module 217 continues to receive energy consumption data for different resources (e.g., processing device 117, memory 121, other storage devices (e.g., HDDs, SSDs), network resources) from each of the above-described sources, it may employ a packet-filter-based approach (e.g., using the extended Berkeley Packet Filter (eBPF)) to attribute the energy consumption data received from each of the above sources to specific services 115 and VMs 113. Because the energy monitor module 217 collects energy consumption data at the kernel level as well, energy consumption data can be attributed to each particular service 115 with as much transparency as possible. In one example, the energy monitor module 217 may be an energy metrics collector such as the Kepler™ (Kubernetes-based Efficient Power Level Exporter) tool, which is an open-source program that provides reporting, reduction, and regression functionalities to help manage energy use. In some embodiments, the energy monitor module 217 may add a general energy usage overhead to the monitored energy consumption data so that the energy consumption data that is provided to the para-virtualization manager 216 is a more accurate picture of the total energy usage of the computing device 130A.

The energy monitor module 217 may include a machine learning (ML) model 218 which may receive as input the energy consumption data from each of the energy monitoring sources described above and learn patterns and trends in the energy usage on a per service 115 and per VM 113 basis as well as the energy usage trends of the computing device 130A itself. The ML model 218 may also learn to generate predicted energy consumption estimates on a per service 115 and per VM 113 basis as well as energy consumption estimates for the computing device 130A itself. By leveraging this model, the energy monitor module 217 provides estimations of workload energy consumption as discussed herein.

Machine learning is well suited for continuous monitoring of one or multiple criteria to identify anomalies or trends, big and small, in input data as compared to training examples used to train the model. The ML model 218 described herein may be trained on an energy consumption training data set that includes energy consumption data from a variety of computing devices executing a variety of VMs, where each VM executes a variety of different services/applications. In some embodiments, the ML model 218 may be trained on an energy consumption training data set that is tailored to suit the design needs for the model. Machine learning models that may be used with embodiments described herein include by way of example and not limitation: Q-learning, Bayes, Markov, Gausian processes, clustering algorithms, generative models, kernel and neural network algorithms. Some embodiments utilize a machine learning model based on a trained neural network (e.g., a trained recurrent neural network (RNN) or a trained convolution neural network (CNN)).

The para-virtualization manager 216 may include decision logic 216A for scaling the resources allocated to the computing device 130A and/or one or more of the VMs 113 based on the energy consumption data provided by the energy monitor module 217, as well as the (per service 115 and per VM 113) energy consumption patterns and predicted energy consumption estimates provided by the energy monitor module 217. The decision logic 216A may scale the resources allocated to the computing device 130A and/or one or more of the VMs 113 in order to optimize the energy usage of the computing device 130A overall. In some embodiments, the energy monitor module 217 may also receive energy consumption data of other computing devices 130 which it may use to make certain resource scaling decisions as discussed in further detail herein.

The para-virtualization manager 216 may determine, based on the received energy consumption data, a utilization level for each of the VMs 113 and in some embodiments, a utilization level of the computing device 130A. For example, the para-virtualization manager 216 may determine which VMs 113 currently have a high utilization or are over utilized (e.g., have a large energy consumption that corresponds to utilizing all or most of their allocated resources and thus draining the battery of the computing device 130A more quickly), which VMs 113 currently have a low utilization or are idling (e.g., have a low energy consumption that corresponds to utilizing a relatively low or insignificant amount of their allocated resources and thus usage of the battery of the computing device 130A is not an issue), and which VMs 113 have a moderate utilization (e.g., have a moderate energy consumption that corresponds to utilizing an expected amount of their allocated resources). It should be noted that the classifications of “high” “moderate” and “low” are for example purposes only and the para-virtualization manager 216 may use a larger set of classifications that classifies VMs in a more fine-grained manner based on their energy usage. The decision logic 216A may implement a rules-based system to enable the para-virtualization manager 216 to use a sliding scale approach to scale the resource allocation of computing device 130A and/or one or more VMs 113 (including taking actions such as migrating a service 115) to ensure optimal resource allocation and energy usage for the computing device 130A and each VM 113. Each rule of the decision logic 216A may include criteria for classifying the energy usage of a computing device 130 or a VM 113, as well as resource scaling actions to take based determining that the computing device 130 or a VM 113 is classified in a particular way.

For example, the decision logic 216A may include a first rule (shown as rule 1 in FIG. 2) that provides an energy usage threshold and a threshold amount of time that a VM 113 must be below the energy usage threshold before the VM 113 may be classified as low utilization. The rule 1 may also include a resource scaling action(s) to take when a VM 113 is classified as low utilization. One example of a resource scaling action may be scaling the resource allocation of the VM 113 down to a bare minimum level. When the para-virtualization manager 216 determines that the VM 113A has been below the energy usage threshold for the threshold amount of time, it may scale the resource allocation of the VM 113A down to the bare minimum level. The rule 1 may further provide that if the VM 113A is using a low amount of energy (e.g., executing one or a small number of low energy usage services 115), the para-virtualization manager 216 may determine the minimum resource allocation level based on the minimum amount of energy required to execute the services 115 executing on VM 113A (e.g., based on the energy consumption data attributed to the services 115 executing on VM 113A).

The rule 1 may further provide that if the VM 113A is an idle state (e.g., not executing any services), the para-virtualization manager 216 may determine the minimum resource allocation level based on the amount of energy required to keep the VM 113A in a particular state based on energy consumption data originating from e.g., the ACPI (and other operating system specific monitoring features). For example, the rule 1 may instruct the para-virtualization manager 216 to determine (in response to the VM 113A being below the energy usage threshold for the threshold amount of time) what power states the VM 113A supports (and the minimum resource requirements to enter and exit each of these power states) from the energy consumption data originating from the ACPI (and other operating system specific monitoring features). From there, the para-virtualization manager 216 may determine which state would result in optimization of the energy usage of the VM 113A (and the computing device 130A) and make resource reallocation decisions based thereon. For example, the rule 1 may dictate that if the VM 113A supports a sleep state (and the sleep state results in energy use optimization), the para-virtualization manager 216 is to adjust the resource allocation of the VM 113 accordingly to put the VM 113A into the sleep state.

Another example of a resource scaling action may be migration of the services 115 executing on the VM 113A and transition of the VM 113A to a sleep state. The rule 1 may instruct the para-virtualization manager 216 to determine if scaling the resource allocation of the VM 113A down to the bare minimum level or migration of the services 115 executing on the VM 113A and transition of the VM 113A to a sleep state would be more energy efficient and take the appropriate action.

The resource scaling actions specified by rule 1 may also include reallocation of the resources that VM 113A was initially allocated that it is no longer using. Some examples of such actions may state that the resources that VM 113A was initially allocated are to be distributed to other VMs 113 based on a workload of each. For example, the rule 1 may state that if any VMs 113 are classified as high utilization, then the remainder of the resources initially allocated to the VM 113A are to be distributed among those VMs 113 that are highly utilized so that they are no longer highly utilized. Another example of resource scaling actions may state that the remainder of the resources initially allocated to the VM 113A are to be distributed to the remaining VMs 113 based on which VMs 113 have the highest workload. The rule 1 may instruct the para-virtualization manager 216 to determine which action will result in optimization of the energy usage of the computing device 130A and the VMs 113 and take the determined action.

The decision logic 216A may include another rule (shown as rule 2 in FIG. 2) that provides criteria (e.g., overutilization energy usage and time limit thresholds) for when a VM 113 may be considered as highly utilized. The rule 2 may also include a resource scaling action(s) to take when a VM 113 is determined to be highly utilized. One example of such an action is migration of one or more services 115 that are running on the VM113 to another VM 113. The rule 2 may also include criteria for determining which services 115 are to be migrated and which VMs 113 those services 115 are to be migrated to. For example, the rule 2 may instruct the para-virtualization manager 216 to identify which services 115 of the VM 113A have the highest energy consumption and migrate one or more of the identified services until the VM 113A is no longer classified as highly utilized. In another example resource scaling action, the rule 2 may instruct the para-virtualization manager 216 to scale the resource allocation of the VM 113A up using resources that have been collected from other VMs 113 that are classified as low utilization as discussed with respect to rule 1. The rule 2 may instruct the para-virtualization manager 216 to determine which action or combination of actions will result in optimization of the energy usage of the computing device 130A and the VMs 113 and take the determined action.

In some embodiments, the rule 2 may also instruct the para-virtualization manager 216 to account for performance of the services 115 running on the VM 113A. For example, if certain services are executing sensitive workloads that cannot be interrupted, then the para-virtualization manager 216 may no longer consider those services as candidates for migration. Further, if migration of certain services would result in the performance of those services being significantly reduced, then the para-virtualization manager 216 may no longer consider that service as a candidate for migration.

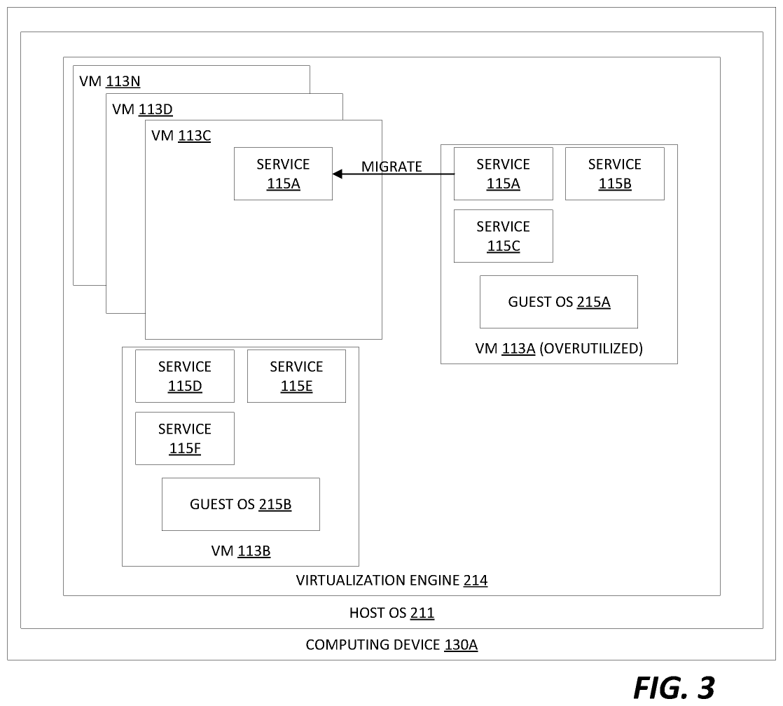

Referring to FIG. 3, the para-virtualization manager 216 may determine that VM 113A is highly utilized and is draining the battery of computing device 130A at a disproportionately high rate compared to other VMs 113. The para-virtualization manager 216 may determine based on the energy consumption data that services 115A and 115C are using significantly more resources than service 115B, and that migration of either service 115A or 115C will result in VM 113A returning to a moderate utilization as well as optimization of the optimization of the energy usage of the computing device 130A and the VMs 113 generally. However, the para-virtualization manager 216 may also determine that service 115C may be running a sensitive workload that cannot be interrupted. Therefore, the para-virtualization manager 216 may determine that service 115A should be migrated. In addition, the para-virtualization manager 216 may determine which VM 113 the service 115A should be migrated to. The rule 2 may instruct the para-virtualization manager 216 to identify which VMs 113 are currently classified as low utilization/idle using the energy consumption data. The para-virtualization manager 216 may determine which VM 113 the service 115A should be migrated to so as to achieve optimal energy usage for the computing device 130A and each of the VMs 113, as well as which VM 113 the service 115A will perform best on when deciding where to migrate service 115A. In the example of FIG. 3, the para-virtualization manager 216 may determine that migration of service 115A to VM 113C will achieve the best energy usage while maintaining the performance of the service 115A and migrate service 115A to VM 113C.

Referring back to FIG. 2, the decision logic 216A may include another rule (shown as rule 3 in FIG. 2) that provides criteria (e.g., high utilization thresholds for energy usage and time limit) for when a computing device (e.g., computing device 130A) may be considered as highly utilized. The rule 3 may also include a resource scaling action(s) to take when the computing device 130A is determined to be highly utilized. One example of such an action is migration of one or more VMs 113 that are running on the computing device 130A to another computing device 130. When the para-virtualization manager 216 determines that the computing device 130A has been above the high utilization energy usage threshold for longer than the high utilization threshold amount of time, it may migrate one or more of the VMs 113 to other computing devices 130. The rule 3 may also include criteria for which VMs 113 are to be migrated and which computing devices those VMs 113 are to be migrated to. For example, the rule 3 may instruct the para-virtualization manager 216 to make VM 113 migration decisions based on energy consumption data for each of the VMs 113, a status of each of the services running on each of the VMs 113 (e.g., whether certain services 115 are running sensitive workloads that cannot be interrupted), and energy consumption data received from each of the other computing devices 130. For example, the para-virtualization manager 216 may identify which VMs 113 are consuming the most energy, which of the identified VMs 113 or which subset of the identified VMs 113 can be migrated to result in the computing device 130A returning back to a moderate utilization, which VMs 113 are appropriate candidates for migration (e.g., based on services 115/workloads running thereon) and which computing devices 130 have sufficient available resources (e.g., are not currently highly utilized themselves) to handle the additional workload. As discussed hereinabove, the para-virtualization manager 216 may use these factors to make a migration decision that will optimize the energy efficiency of the computing device 130A as well as the energy efficiency of the computing device 130 that the VMs 113 are migrated to.

Still other rules of the decision logic 216A may provide criteria based on predicted energy consumption estimates generated by the ML model 218. For example, a particular rule (shown as rule 4 in FIG. 2) may indicate that if a VM 113B is predicted to be low utilization/idle for longer than a threshold amount of time, then certain resource scaling actions are to be taken. For example, the para-virtualization manager 216 may receive a predicted energy consumption estimate indicating that the VM 113B is idle during the hours of 12:00 AM to 7 AM every day. Thus, rule 4 may dictate that every night at 12:00 AM, the para-virtualization manager 216 may perform the resource scaling actions indicated by the rule 4. The resource scaling actions may include those discussed above with respect to rule 1 as well as any other appropriate rule scaling actions or combination thereof.

It should be noted that the example rules described above are for example purposes only and are not intended to be limiting. The decision logic 216A may include rules that include any appropriate combination of classification criteria and resource scaling actions discussed above. It should be noted that the example rules are described above as having criteria defined in terms of thresholds (e.g., for energy consumption and time). However, this is not a limitation and the criteria specified by a rule of the decision logic 216A to trigger the corresponding resource scaling actions may be specified in terms of ranges or any other appropriate metrics.

As the energy usage of the computing device 130A and each of the VMs 113 (and their respective services 115) continues to change, the energy monitor module 217 may continue to provide energy consumption data reflective of such changes to the para-virtualization manager 216, which may continue to adapt the resource allocation of the computing device 130A and/or one or more of the VMs 113 to respond to the changes in the energy usage of the computing device 130A and each of the VMs 113 (and their respective services 115). In this way, the para-virtualization manager 216 may maintain optimal performance of each of the services 115/VMs 113 and the computing device 130A while also minimizing energy consumption. The para-virtualization manager 216 may adapt the resource allocation of the computing device 130A and/or one or more of the VMs 113 to respond to the changes in the energy usage thereof continuously e.g., at regular intervals or in response to such changes themselves (or in response to certain types of changes).

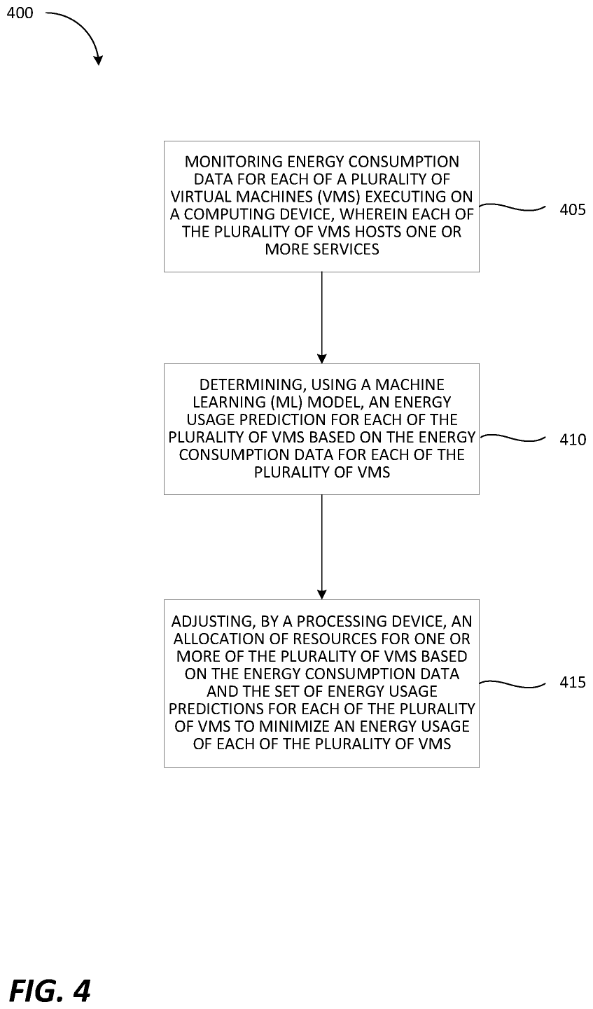

FIG. 4 is a flow diagram of a method 400 for optimizing energy usage of a computing device running one or more VMs, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 130A illustrated in FIGS. 1-3).

Referring also to FIG. 2, at block 405 the energy monitor module 217 may use hardware and software performance counters, hardware-specific monitoring features and operating system-specific features to monitor energy consumption data on a per VM 113 and per service 115 basis. The energy monitor module 217 may also utilize machine learning models to learn/estimate energy consumption on a per VM 113 and per service 115 basis. The para-virtualization manager 216 may use the energy consumption data and energy consumption estimates received from the energy monitor module 217 to scale the amount of resources allocated to certain VMs 113 as discussed in further detail herein. Energy consumption data may refer to the energy consumption attributable to each of the different resources (e.g., CPU, memory and networking resources of computing device 130A) in the aggregate.

The energy monitor module 217 may use a set of hardware performance counters which may each be a special-purpose register built into a CPU or processing device of the computing device 130A to count certain events that take place at the CPU level, such as the number of cycles and instructions that a service 115 executed, its associated cache misses and accesses to off-chip memory, among other examples. The energy monitor module 217 may also use a set of software performance counters, each of which may comprise code that monitors, counts, or measures events in the services 115.

The energy monitor module 217 may also use hardware-specific monitoring features such as e.g., the running average power limit (RAPL), which is a feature of CPUs that provides information about the energy consumption of different domains (e.g., CPU or RAM) in real time. The energy monitor module 217 may also use operating system-specific monitoring features such as e.g., the advanced configuration and power interface (ACPI), which is an open standard that operating systems can use to discover and configure computer hardware components. More specifically, the ACPI interface provides information including e.g., the power management features and different power states (e.g., active, idle, sleep) that the computing device 130A (and each VM 113) supports, a description of what power resources (power planes and clock sources) the computing device 130A needs in each power state that it supports, and a description of what power resources the computing device 130A needs in order to return to the active state from a sleeping or idle state.

As the energy monitor module 217 continues to receive energy consumption data for different resources (e.g., CPU, memory and networking resources) from each of the above-described sources, it may employ a packet-filter-based approach (e.g., using the extended Berkeley Packet Filter (eBPF)) to attribute the energy consumption data received from each of the above sources to specific services 115 and VMs 113. In some embodiments, the energy monitor module 217 may collect energy consumption data at the kernel level as well so that energy consumption can be attributed to each particular service 115 with as much transparency as possible. In one example, the energy monitor module 217 may be an energy metrics collector such as the Kepler™ (Kubernetes-based Efficient Power Level Exporter) tool, which is an open-source program that provides reporting, reduction, and regression functionalities to help manage energy use. In some embodiments, the energy monitor module 217 may add a general energy usage overhead to the monitored energy consumption data so that the energy consumption data that is provided to the para-virtualization manager 216 is a more accurate picture of the total energy usage of the computing device 130A.

The energy monitor module 217 may include a machine learning (ML) model 218 which may receive as input the energy consumption data from each of the energy monitoring sources described above and learn patterns and trends in the energy usage on a per service 115 and per VM 113 basis as well as the energy usage trends of the computing device 130A itself. At block 410, the ML model 218 may generate predicted energy consumption estimates on a per service 115 and per VM 113 basis as well as energy consumption estimates for the computing device 130A itself. By leveraging this model, the energy monitor module 217 provides estimations of workload energy consumption as discussed herein.

Ay block 415, para-virtualization manager 216 may scale the resources allocated to the computing device 130A and/or one or more of the VMs 113 based on the energy consumption data provided by the energy monitor module 217, as well as the (per service 115 and per VM 113) energy consumption patterns and predicted energy consumption estimates provided by the energy monitor module 217. The decision logic 216A may scale the resources allocated to the computing device 130A and/or one or more of the VMs 113 in order to optimize the energy usage of the computing device 130A overall. In some embodiments, the energy monitor module 217 may also receive energy consumption data of other computing devices 130 which it may use to make certain resource scaling decisions as discussed in further detail herein.

The para-virtualization manager 216 may determine, based on the received energy consumption data, a utilization level for each of the VMs 113 and in some embodiments, a utilization level of the computing device 130A. For example, the para-virtualization manager 216 may determine which VMs 113 currently have a high utilization or are over utilized (e.g., have a large energy consumption that corresponds to utilizing all or most of their allocated resources and thus draining the battery of the computing device 130A more quickly), which VMs 113 currently have a low utilization or are idling (e.g., have a low energy consumption that corresponds to utilizing a relatively low or insignificant amount of their allocated resources and thus usage of the battery of the computing device 130A is not an issue), and which VMs 113 have a moderate utilization (e.g., have a moderate energy consumption that corresponds to utilizing an expected amount of their allocated resources). It should be noted that the classifications of “high” “moderate” and “low” are for example purposes only and the para-virtualization manager 216 may use a larger set of classifications that classifies VMs in a more fine-grained manner based on their energy usage. The decision logic 216A may implement a rules-based system to enable the para-virtualization manager 216 to use a sliding scale approach to scale the resource allocation of computing device 130A and/or one or more VMs 113 (including taking actions such as migrating a service 115) to ensure optimal resource allocation and energy usage for the computing device 130A and each VM 113. Each rule of the decision logic 216A may include criteria for classifying the energy usage of a computing device 130 or a VM 113, as well as resource scaling actions to take based determining that the computing device 130 or a VM 113 is classified in a particular way.

For example, the decision logic 216A may include a first rule (shown as rule 1 in FIG. 2) that provides an energy usage threshold and a threshold amount of time that a VM 113 must be below the energy usage threshold before the VM 113 may be classified as low utilization. The rule 1 may also include a resource scaling action(s) to take when a VM 113 is classified as low utilization. One example of a resource scaling action may be scaling the resource allocation of the VM 113 down to a bare minimum level. When the para-virtualization manager 216 determines that the VM 113A has been below the energy usage threshold for the threshold amount of time, it may scale the resource allocation of the VM 113A down to the bare minimum level. The rule 1 may further provide that if the VM 113A is using a low amount of energy (e.g., executing one or a small number of low energy usage services 115), the para-virtualization manager 216 may determine the minimum resource allocation level based on the minimum amount of energy required to execute the services 115 executing on VM 113A (e.g., based on the energy consumption data attributed to the services 115 executing on VM 113A).

The rule 1 may further provide that if the VM 113A is an idle state (e.g., not executing any services), the para-virtualization manager 216 may determine the minimum resource allocation level based on the amount of energy required to keep the VM 113A in a particular state based on energy consumption data originating from e.g., the ACPI (and other operating system specific monitoring features). For example, the rule 1 may instruct the para-virtualization manager 216 to determine (in response to the VM 113A being below the energy usage threshold for the threshold amount of time) what power states the VM 113A supports (and the minimum resource requirements to enter and exit each of these power states) from the energy consumption data originating from the ACPI (and other operating system specific monitoring features). From there, the para-virtualization manager 216 may determine which state would result in optimization of the energy usage of the VM 113A (and the computing device 130A) and make resource reallocation decisions based thereon. For example, the rule 1 may dictate that if the VM 113A supports a sleep state (and the sleep state results in energy use optimization), the para-virtualization manager 216 is to adjust the resource allocation of the VM 113 accordingly to put the VM 113A into the sleep state.

Another example of a resource scaling action may be migration of the services 115 executing on the VM 113A and transition of the VM 113A to a sleep state. The rule 1 may instruct the para-virtualization manager 216 to determine if scaling the resource allocation of the VM 113A down to the bare minimum level or migration of the services 115 executing on the VM 113A and transition of the VM 113A to a sleep state would be more energy efficient and take the appropriate action.

The resource scaling actions specified by rule 1 may also include reallocation of the resources that VM 113A was initially allocated that it is no longer using. Some examples of such actions may state that the resources that VM 113A was initially allocated are to be distributed to other VMs 113 based on a workload of each. For example, the rule 1 may state that if any VMs 113 are classified as high utilization, then the remainder of the resources initially allocated to the VM 113A are to be distributed among those VMs 113 that are highly utilized so that they are no longer highly utilized. Another example of resource scaling actions may state that the remainder of the resources initially allocated to the VM 113A are to be distributed to the remaining VMs 113 based on which VMs 113 have the highest workload. The rule 1 may instruct the para-virtualization manager 216 to determine which action will result in optimization of the energy usage of the computing device 130A and the VMs 113 and take the determined action.

The decision logic 216A may include another rule (shown as rule 2 in FIG. 2) that provides criteria (e.g., overutilization energy usage and time limit thresholds) for when a VM 113 may be considered as highly utilized. The rule 2 may also include a resource scaling action(s) to take when a VM 113 is determined to be highly utilized. One example of such an action is migration of one or more services 115 that are running on the VM113 to another VM 113. The rule 2 may also include criteria for determining which services 115 are to be migrated and which VMs 113 those services 115 are to be migrated to. For example, the rule 2 may instruct the para-virtualization manager 216 to identify which services 115 of the VM 113A have the highest energy consumption and migrate one or more of the identified services until the VM 113A is no longer classified as highly utilized. In another example resource scaling action, the rule 2 may instruct the para-virtualization manager 216 to scale the resource allocation of the VM 113A up using resources that have been collected from other VMs 113 that are classified as low utilization as discussed with respect to rule 1. The rule 2 may instruct the para-virtualization manager 216 to determine which action or combination of actions will result in optimization of the energy usage of the computing device 130A and the VMs 113 and take the determined action.

In some embodiments, the rule 2 may also instruct the para-virtualization manager 216 to account for performance of the services 115 running on the VM 113A. For example, if certain services are executing sensitive workloads that cannot be interrupted, then the para-virtualization manager 216 may no longer consider those services as candidates for migration. Further, if migration of certain services would result in the performance of those services being significantly reduced, then the para-virtualization manager 216 may no longer consider that service as a candidate for migration.

Referring to FIG. 3, the para-virtualization manager 216 may determine that VM 113A is highly utilized and is draining the battery of computing device 130A at a disproportionately high rate compared to other VMs 113. The para-virtualization manager 216 may determine based on the energy consumption data that services 115A and 115C are using significantly more resources than service 115B, and that migration of either service 115A or 115C will result in VM 113A returning to a moderate utilization as well as optimization of the optimization of the energy usage of the computing device 130A and the VMs 113 generally. However, the para-virtualization manager 216 may also determine that service 115C may be running a sensitive workload that cannot be interrupted. Therefore, the para-virtualization manager 216 may determine that service 115A should be migrated. In addition, the para-virtualization manager 216 may determine which VM 113 the service 115A should be migrated to. The rule 2 may instruct the para-virtualization manager 216 to identify which VMs 113 are currently classified as low utilization/idle using the energy consumption data. The para-virtualization manager 216 may determine which VM 113 the service 115A should be migrated to so as to achieve optimal energy usage for the computing device 130A and each of the VMs 113, as well as which VM 113 the service 115A will perform best on when deciding where to migrate service 115A. In the example of FIG. 3, the para-virtualization manager 216 may determine that migration of service 115A to VM 113C will achieve the best energy usage while maintaining the performance of the service 115A and migrate service 115A to VM 113C.

Referring back to FIG. 2, the decision logic 216A may include another rule (shown as rule 3 in FIG. 2) that provides criteria (e.g., high utilization thresholds for energy usage and time limit) for when a computing device (e.g., computing device 130A) may be considered as highly utilized. The rule 3 may also include a resource scaling action(s) to take when the computing device 130A is determined to be highly utilized. One example of such an action is migration of one or more VMs 113 that are running on the computing device 130A to another computing device 130. When the para-virtualization manager 216 determines that the computing device 130A has been above the high utilization energy usage threshold for longer than the high utilization threshold amount of time, it may migrate one or more of the VMs 113 to other computing devices 130. The rule 3 may also include criteria for which VMs 113 are to be migrated and which computing devices those VMs 113 are to be migrated to. For example, the rule 3 may instruct the para-virtualization manager 216 to make VM 113 migration decisions based on energy consumption data for each of the VMs 113, a status of each of the services running on each of the VMs 113 (e.g., whether certain services 115 are running sensitive workloads that cannot be interrupted), and energy consumption data received from each of the other computing devices 130. For example, the para-virtualization manager 216 may identify which VMs 113 are consuming the most energy, which of the identified VMs 113 or which subset of the identified VMs 113 can be migrated to result in the computing device 130A returning back to a moderate utilization, which VMs 113 are appropriate candidates for migration (e.g., based on services 115/workloads running thereon) and which computing devices 130 have sufficient available resources (e.g., are not currently highly utilized themselves) to handle the additional workload. As discussed hereinabove, the para-virtualization manager 216 may use these factors to make a migration decision that will optimize the energy efficiency of the computing device 130A as well as the energy efficiency of the computing device 130 that the VMs 113 are migrated to.

Still other rules of the decision logic 216A may provide criteria based on predicted energy consumption estimates generated by the ML model 218. For example, a particular rule (shown as rule 4 in FIG. 2) may indicate that if a VM 113B is predicted to be low utilization/idle for longer than a threshold amount of time, then certain resource scaling actions are to be taken. For example, the para-virtualization manager 216 may receive a predicted energy consumption estimate indicating that the VM 113B is idle during the hours of 12:00 AM to 7 AM every day. Thus, rule 4 may dictate that every night at 12:00 AM, the para-virtualization manager 216 may perform the resource scaling actions indicated by the rule 4. The resource scaling actions may include those discussed above with respect to rule 1 as well as any other appropriate rule scaling actions or combination thereof.

As the energy usage of the computing device 130A and each of the VMs 113 (and their respective services 115) continues to change, the energy monitor module 217 may continue to provide energy consumption data reflective of such changes to the para-virtualization manager 216, which may continue to adapt the resource allocation of the computing device 130A and/or one or more of the VMs 113 to respond to the changes in the energy usage of the computing device 130A and each of the VMs 113 (and their respective services 115). In this way, the para-virtualization manager 216 may maintain optimal performance of each of the services 115/VMs 113 and the computing device 130A while also minimizing energy consumption. The para-virtualization manager 216 may adapt the resource allocation of the computing device 130A and/or one or more of the VMs 113 to respond to the changes in the energy usage thereof continuously e.g., at regular intervals or in response to such changes themselves (or in response to certain types of changes).

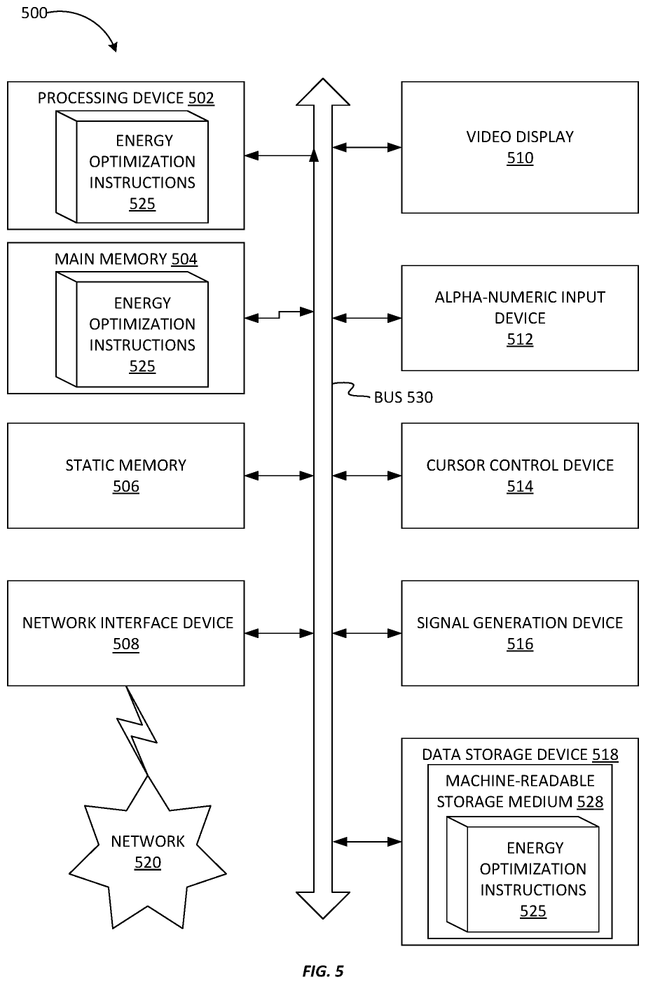

FIG. 5 illustrates a diagrammatic representation of a machine in the example form of a computer system 500 within which a set of instructions, for causing the machine to perform any one or more of the methodologies discussed herein for optimizing energy usage of a computing device running one or more VMs, in accordance with some embodiments of the present disclosure.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute energy optimization instructions 525, for performing the operations and steps discussed herein.

The data storage device 518 may include a machine-readable storage medium 528, on which is stored one or more sets of energy optimization instructions 525 (e.g., software) embodying any one or more of the methodologies of functions described herein. The energy optimization instructions 525 may also reside, completely or at least partially, within the main memory 504 or within the processing device 502 during execution thereof by the computer system 500; the main memory 504 and the processing device 502 also constituting machine-readable storage media. The energy optimization instructions 525 may further be transmitted or received over a network 520 via the network interface device 508.

The machine-readable storage medium 528 may also be used to store instructions to perform a method for optimizing energy usage of a computing device running one or more VMs. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “monitoring,” “determining,” “adjusting,” “migrating,” “scaling” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
monitoring energy consumption data for each of a plurality of virtual machines (VMs) executing on a computing device, wherein each of the plurality of VMs hosts one or more services;
determining, using a machine learning (ML) model, an energy usage prediction for each of the plurality of VMs based on the energy consumption data for each of the plurality of VMs; and
adjusting, by a processing device, an allocation of resources for one or more of the plurality of VMs based on the energy consumption data and the set of energy usage predictions for each of the plurality of VMs to minimize an energy usage of each of the plurality of VMs.

2. The method of claim 1, wherein each of the plurality of VMs is executed as a para-virtualization by a para-virtualization management module, and wherein the para-virtualization management module comprises a set of rules for adjusting the allocation of resources for each of the one or more VMs.

3. The method of claim 1, wherein the energy consumption data for a first VM of the plurality of VMs indicates that the first VM is highly utilized, and wherein adjusting the allocation of resources for the one or more of the plurality of VMs comprises adjusting the allocation of resources for the first VM by:
migrating one or more services executing on the first VM to one or more other VMs of the plurality of VMs; and
scaling an initial allocation of resources of the first VM up to a level where the first VM is no longer highly utilized.

4. The method of claim 1, wherein the energy consumption data for a first VM of the plurality of VMs indicates that the first VM is highly utilized, and wherein adjusting the allocation of resources for the one or more of the plurality of VMs comprises adjusting the allocation of resources for the first VM by:
determining that the first VM supports a sleep state;
scaling an initial allocation of resources of the first VM down to a minimum level required for the sleep state; and
allocating a remainder of the initial allocation of resources of the first VM to one or more other VMs of the plurality of VMs.

5. The method of claim 1, wherein the energy usage prediction for a first VM of the plurality of VMs indicates that the first VM has a low utilization during a time period between a first time and a second time, and wherein adjusting the allocation of resources for the one or more of the plurality of VMs comprises adjusting the allocation of resources for the first VM by:
at the first time, scaling an initial allocation of resources of the first VM down to a minimum allocation of resources;
allocating a remainder of the initial allocation of resources of the first VM to one or more other VMs of the plurality of VMs; and
at the second time, scaling the minimum allocation of resources of the first VM up to an allocation of resources required for the first VM to operate outside of the time period.

6. The method of claim 1, wherein the allocation of resources for each of the plurality of VMs comprises:
an allocation of memory of the computing device;
allocation of central processing unit (CPU) capability of the computing device; and
an allocation of network resources of the computing device.

7. The method of claim 1, wherein the ML model comprises a Q-learning model.

8. A system comprising:
a memory; and
a processing device operatively coupled to the memory, the processing device to:
monitor energy consumption data for each of a plurality of virtual machines (VMs) executing on a computing device, wherein each of the plurality of VMs hosts one or more services;
determine, using a machine learning (ML) model, an energy usage prediction for each of the plurality of VMs based on the energy consumption data for each of the plurality of VMs; and
adjust an allocation of resources for one or more of the plurality of VMs based on the energy consumption data and the set of energy usage predictions for each of the plurality of VMs to minimize an energy usage of each of the plurality of VMs.

9. The system of claim 8, wherein the processing device executes each of the plurality of VMs as a para-virtualization using a para-virtualization management module, and wherein the para-virtualization management module comprises a set of rules for adjusting the allocation of resources for each of the one or more VMs.

10. The system of claim 8, wherein the energy consumption data for a first VM of the plurality of VMs indicates that the first VM is highly utilized, and wherein to adjust the allocation of resources for the one or more of the plurality of VMs, the processing device is to adjust the allocation of resources for the first VM by:
migrating one or more services executing on the first VM to one or more other VMs of the plurality of VMs; and
scaling an initial allocation of resources of the first VM up to a level where the first VM is no longer highly utilized.

11. The system of claim 8, wherein the energy consumption data for a first VM of the plurality of VMs indicates that the first VM is highly utilized, and wherein to adjust the allocation of resources for the one or more of the plurality of VMs, the processing device is to adjust the allocation of resources for the first VM by:
determining that the first VM supports a sleep state;
scaling an initial allocation of resources of the first VM down to a minimum level required for the sleep state; and
allocating a remainder of the initial allocation of resources of the first VM to one or more other VMs of the plurality of VMs.

12. The system of claim 8, wherein the energy usage prediction for a first VM of the plurality of VMs indicates that the first VM has a low utilization during a time period between a first time and a second time, and wherein to adjust the allocation of resources for the one or more of the plurality of VMs, the processing device is to adjust the allocation of resources for the first VM by:
at the first time, scaling an initial allocation of resources of the first VM down to a minimum allocation of resources;
allocating a remainder of the initial allocation of resources of the first VM to one or more other VMs of the plurality of VMs; and
at the second time, scaling the minimum allocation of resources of the first VM up to an allocation of resources required for the first VM to operate outside of the time period.

13. The system of claim 8, wherein the allocation of resources for each of the plurality of VMs comprises:
an allocation of memory of the computing device;
allocation of central processing unit (CPU) capability of the computing device; and
an allocation of network resources of the computing device.

14. The system of claim 8, wherein the ML model comprises a Q-learning model.

15. A non-transitory computer-readable medium having instructions stored thereon which, when executed by a processing device, cause the processing device to:
monitor energy consumption data for each of a plurality of virtual machines (VMs) executing on a computing device, wherein each of the plurality of VMs hosts one or more services;
determine, using a machine learning (ML) model, an energy usage prediction for each of the plurality of VMs based on the energy consumption data for each of the plurality of VMs; and
adjust, by the processing device, an allocation of resources for one or more of the plurality of VMs based on the energy consumption data and the set of energy usage predictions for each of the plurality of VMs to minimize an energy usage of each of the plurality of VMs.

16. The non-transitory computer-readable medium of claim 15, wherein the processing device executes each of the plurality of VMs as a para-virtualization using a para-virtualization management module, and wherein the para-virtualization management module comprises a set of rules for adjusting the allocation of resources for each of the one or more VMs.

17. The non-transitory computer-readable medium of claim 15, wherein the energy consumption data for a first VM of the plurality of VMs indicates that the first VM is highly utilized, and wherein to adjust the allocation of resources for the one or more of the plurality of VMs, the processing device is to adjust the allocation of resources for the first VM by:
migrating one or more services executing on the first VM to one or more other VMs of the plurality of VMs; and
scaling an initial allocation of resources of the first VM up to a level where the first VM is no longer highly utilized.

18. The non-transitory computer-readable medium of claim 15, wherein the energy consumption data for a first VM of the plurality of VMs indicates that the first VM is highly utilized, and wherein to adjust the allocation of resources for the one or more of the plurality of VMs, the processing device is to adjust the allocation of resources for the first VM by:
determining that the first VM supports a sleep state;
scaling an initial allocation of resources of the first VM down to a minimum level required for the sleep state; and
allocating a remainder of the initial allocation of resources of the first VM to one or more other VMs of the plurality of VMs.

19. The non-transitory computer-readable medium of claim 15, wherein the energy usage prediction for a first VM of the plurality of VMs indicates that the first VM has a low utilization during a time period between a first time and a second time, and wherein to adjust the allocation of resources for the one or more of the plurality of VMs, the processing device is to adjust the allocation of resources for the first VM by:
at the first time, scaling an initial allocation of resources of the first VM down to a minimum allocation of resources;
allocating a remainder of the initial allocation of resources of the first VM to one or more other VMs of the plurality of VMs; and
at the second time, scaling the minimum allocation of resources of the first VM up to an allocation of resources required for the first VM to operate outside of the time period.

20. The non-transitory computer-readable medium of claim 15, wherein the allocation of resources for each of the plurality of VMs comprises:
an allocation of memory of the computing device;
allocation of central processing unit (CPU) capability of the computing device; and
an allocation of network resources of the computing device.
